(19) United States
(12) Patent Application Publication
(10) Pub. No.: US 2024/0075594 A1
(43) Pub. Date: Mar. 7, 2024

(54) Chain Wrench Assembly

(71) Applicant: Chris Ellis, Newton, NJ (US)

(72) Inventor: Chris Ellis, Newton, NJ (US)

(21) Appl. No.: 17/902,851

(22) Filed: Sep. 4, 2022

(51) Int. Cl. B25B 13/52

(52) U.S. Cl. CPC B25B 13/52

(57) ABSTRACT

A chain wrench assembly for tightening or loosening a fastener includes a handle that has a heel which is positionable against a head of a fastener. A chain is coupled to the handle and the chain is extendable around the head of the fastener to form a closed loop around the head of the fastener. The chain has a plurality of gripping elements to engage the head of the fastener thereby facilitating the chain to rotate the head of the fastener when the handle is manipulated for tightening or loosening the fastener.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to wrench devices and more particularly pertains to a new wrench device for tightening or loosening fasteners. The device includes a handle and a chain that is attached to the handle and the chain can be wrapped around the head of a fastener. An adjuster is movably attached to the handle and the adjuster engages the chain for either tightening or loosening the chain around the head of the fastener.

### (2) Description of Related Art Including Information Disclosed Under 37 CFR 1.97 and 1.98

The prior art relates to wrench devices including a socket wrench device that includes a plurality of stackable sockets that can serve as an extension. The prior art discloses an adaptable wrench assembly that comprises a plurality of box end wrenches that are attachable together with a plurality of attachment elements for accessing fasteners in difficult to reach locations. The prior art discloses a wrench device that includes a handle, a curved extension with a plurality of attachment locations and a head that is attachable to the curved extension. The prior art discloses a spherical ratchet device that includes a plurality of socket extensions radiating outwardly from a sphere. The prior art discloses an adjustable socket wrench device that includes a gear train for transferring rotational torque.

### BRIEF SUMMARY OF THE INVENTION

An embodiment of the disclosure meets the needs presented above by generally comprising a handle that has a heel which is positionable against a head of a fastener. A chain is coupled to the handle and the chain is extendable around the head of the fastener to form a closed loop around the head of the fastener. The chain has a plurality of gripping elements to engage the head of the fastener thereby facilitating the chain to rotate the head of the fastener when the handle is manipulated for tightening or loosening the fastener.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a chain wrench assembly according to an embodiment of the disclosure.

FIG. 2 is a bottom perspective view of an embodiment of the disclosure.

FIG. 3 is a perspective view of an embodiment of the disclosure.

FIG. 4 is a cut-away view of a handle of an embodiment of the disclosure.

FIG. 5 is a perspective in-use view of an embodiment of the disclosure.

### DETAILED DESCRIPTION OF THE INVENTION

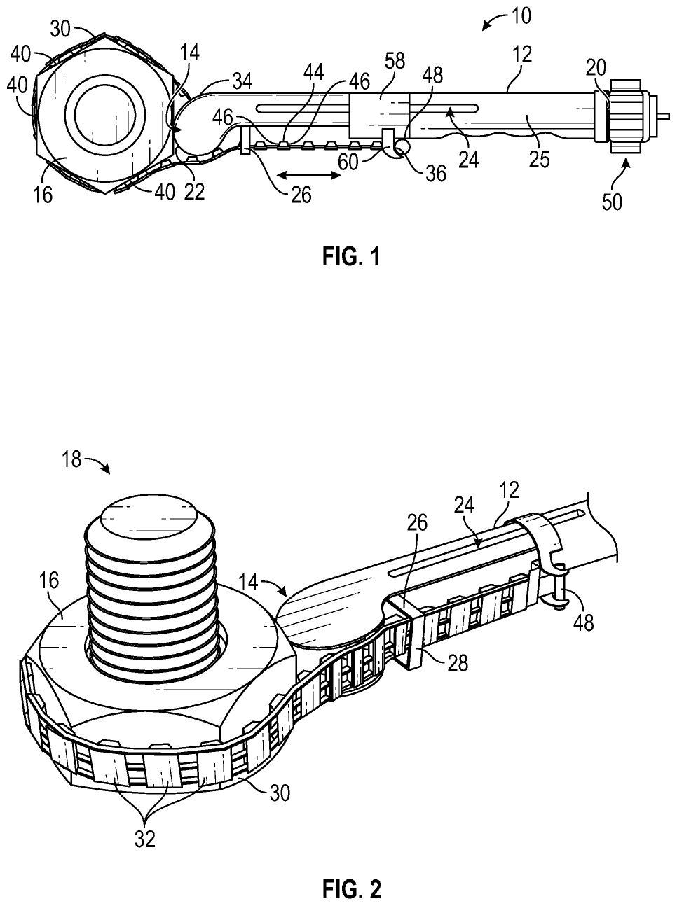

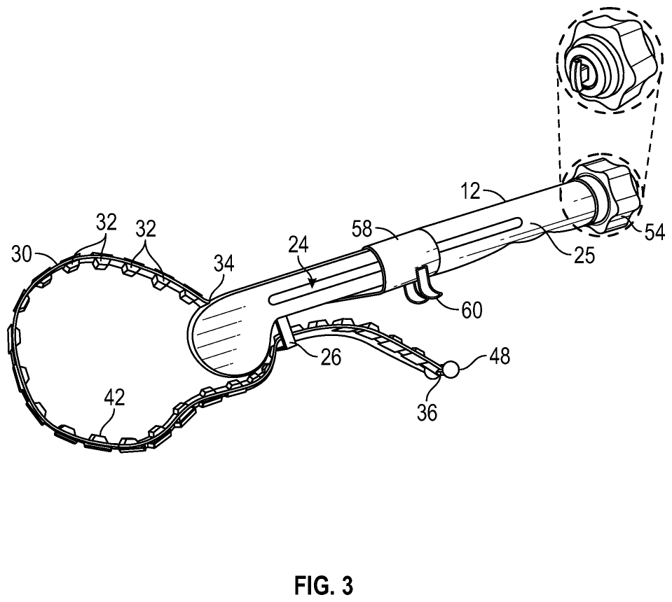

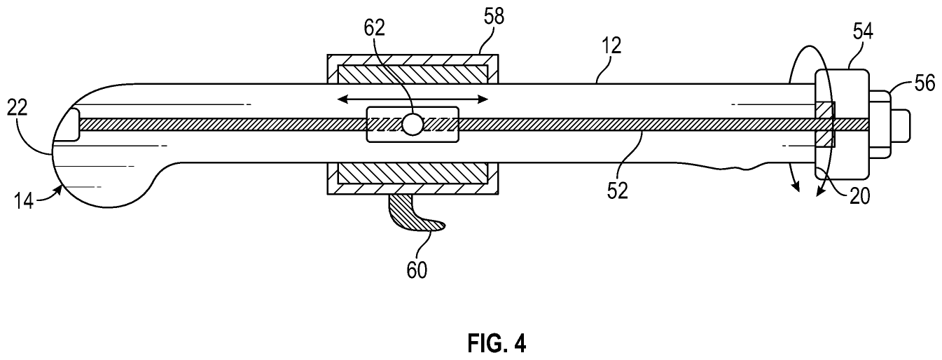

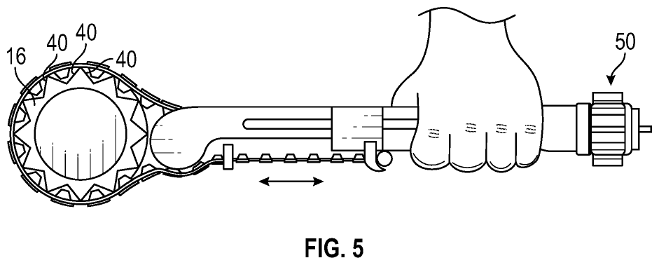

With reference now to the drawings, and in particular to FIGS. 1 through 5 thereof, a new wrench device embodying the principles and concepts of an embodiment of the disclosure and generally designated by the reference numeral 10 will be described.

As best illustrated in FIGS. 1 through 5, the chain wrench assembly 10 generally comprises a handle 12 that has a heel 14 which is positionable against a head 16 of a fastener 18. The fastener 18 may be a bolt, for example, or other type of threaded fastener that would commonly be found in a mechanical application, such as in the automotive industry or the aircraft industry. Furthermore, the head 16 of the fastener 18 may be a hex head or other type of head that would commonly be manipulated with a socket wrench, a box end wrench or an open end wrench. The handle 12 has a first end and a second end 22 and the second end 22 is rounded to define the heel 14. Furthermore, the heel 14 curves away from a centerline of the handle 12 which extends between the first end 20 and the second end 22. The handle 12 is substantially hollow and the handle 12 has an adjustment slot 24 extending through an outer wall 25 of the handle 12. The adjustment slot 24 is elongated to extend a substantial length between the first end 20 and the second end 22. A slide 26 is attached to the handle 12 and the slide 26 is spaced from the heel 14. The slide 26 has a member 28 that is spaced from the outer wall 25 of the handle 12 and the slide 26 is positioned between the heel 14 and the adjustment slot 24.

A chain 30 is coupled to the handle 12 and the chain 30 is extendable around the head 16 of the fastener 18. The chain 30 slides through the slide 26 such that the chain 30 forms a closed loop around the head 16 of the fastener 18. The chain 30 has a plurality of gripping elements 32 that is each integrated into the chain 30 and each of the gripping elements 32 engages the head 16 of the fastener 18. In this way the chain 30 can rotate the head 16 of the fastener 18 when the handle 12 is manipulated for tightening or loosening the fastener 18. Furthermore, the chain 30 can accommodate a wide variety of sizes of fasteners. Thus, a fastener that is located in a location that is not accessible to a socket wrench, for example, can be tightened or loosened.

The chain 30 has a primary end 34, a secondary end 36 and an engaging surface 38 extending between the primary end 34 and the secondary end 36 and the primary end 34 is coupled to the heel 14. Each of the gripping elements 32 is disposed on the engaging surface 38 and the gripping elements 32 are evenly spaced apart from each other and are distributed between the primary end 34 and the secondary end 36. In this way the gripping elements 32 can accommodate angles between intersecting faces 40 of the head 16 of the fastener 18. Each of the gripping elements 32 has an outer surface 42 which has a top side 44 and a pair of lateral sides 46 each sloping outwardly between the top side 44 and the engaging surface 38 of the chain 30 such that each of the gripping elements 32 has a trapezoidal shape. In this way the gripping elements 32 do not abut against each other when the chain 30 is wrapped around the head 16 of the fastener 18. Additionally, a bar 48 is disposed on the secondary end 36 of the chain 30.

An adjuster 50 is movably integrated into the handle 12 and the adjuster 50 engages the chain 30. The adjuster 50 tightens the chain 30 around the head 16 of the fastener 18 when the adjuster 50 is manipulated in a tightening condition. Conversely, the adjuster 50 loosens the chain 30 around the head 16 of the fastener 18 when the adjuster 50 is manipulated in a loosening condition. The adjuster 50 comprises a screw 52 that is rotatably disposed within the handle 12. The screw 52 extends between the first end 20 and the second end 22 of the handle 12 and the screw 52 is aligned with the adjustment slot 24 in the outer wall 25 of the handle 12.

The adjuster 50 includes a knob 54 that is rotatably disposed on the first end 20 of the handle 12 thereby facilitating the knob 54 to be rotated. The screw 52 is attached to the knob 54 such that the screw 52 rotates when the knob 54 is rotated and the knob 54 is rotatable in a first direction or a second direction. A nut 56 is rotatably attached to the knob 54 and the nut 56 compresses the knob 54 against the first end 20 of the handle 12 when the nut 56 is tightened to inhibit the knob 54 from rotating. Conversely, the nut 56 disengages the knob 54 when the nut 56 is loosened to facilitate the knob 54 to be rotated.

The adjuster 50 includes a sleeve 58 that is positioned around the handle 12 and the sleeve 58 is slidable between the first end 20 and the second end 22 of the handle 12. A hook 60 is coupled to and extends downwardly from the sleeve 58 and the hook 60 curves toward the first end 20 of the handle 12. The hook 60 engages the bar 48 on the secondary end 36 of the chain 30. The adjuster 50 includes a pin 62 that is coupled to the sleeve 58 and which extends through the adjustment slot 24 in the outer wall 25 of the handle 12. The screw 52 extends through the pin 62 such that the pin 62 threadably engages the screw 52 thereby facilitating the pin 62 to travel along the screw 52 when the screw 52 is rotated. The sleeve 58 travels toward the first end 20 of the handle 12 when the knob 54 is rotated in the first direction thereby tightening the chain 30 around the head 16 of the fastener 18. Conversely, the sleeve 58 travels toward the second end 22 of the handle 12 when the knob 54 is rotated in the second direction thereby loosening the chain 30 around the head 16 of the fastener 18.

In use, the adjuster 50 is manipulated to sufficiently loosen the chain 30 to facilitate the chain 30 to be positioned around the head 16 of the fastener 18. The adjuster 50 is manipulated to tighten the chain 30 around the head 16 of the fastener 18 until the heel 14 of the handle 12 is abutted against the head 16 of the fastener 18. In this way the handle 12 can be manipulated to either tighten or loosen the fastener 18 in the convention of a wrench. Furthermore, a variety of different sizes and types of fasteners can be tightened or loosened with the handle 12 and the chain 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A chain wrench assembly being wrappable around a head of a fastener for tightening or loosening the fastener, said assembly comprising:
a handle having a heel being positionable against a head of a fastener; and
a chain being coupled to said handle, said chain being extendable around the head of the fastener, said chain forming a closed loop around the head of the fastener, said chain having a plurality of gripping elements each being integrated into said chain, each of said gripping elements engaging the head of the fastener thereby facilitating said chain to rotate the head of the fastener when said handle is manipulated for tightening or loosening the fastener.

2. The assembly according to claim 1, wherein:
said handle has a first end and a second end, said second end being rounded to define said heel, said heel curving away from a centerline of said handle extending between said first end and said second end;
said handle is substantially hollow;
said handle has an adjustment slot extending through an outer wall of said handle, said adjustment slot being elongated to extend a substantial length between said first end and said second end; and
said slide has a member being spaced from said outer wall of said handle, said slide being positioned between said heel and said adjustment slot.

3. The assembly according to claim 2, wherein said chain has a primary end, a secondary end and an engaging surface extending between said primary end and said secondary end, said primary end being coupled to said heel, each of said gripping elements being disposed on said engaging surface, said gripping elements being evenly spaced apart from each other and being distributed between said primary end and said secondary end thereby facilitating said gripping elements to accommodate angles between intersecting faces of the head of the fastener.

4. The assembly according to claim 3, wherein each of said gripping elements has an outer surface which has a top side and a pair of lateral sides each sloping outwardly between said top side and said engaging surface of said chain such that each of said gripping elements has a trapezoidal shape.

5. The assembly according to claim 2, further comprising an adjuster being movably integrated into said handle, said adjuster engaging said chain, said adjuster travelling along said adjustment slot in said outer wall of said handle, said adjuster tightening said chain around the head of the fastener when said adjuster is manipulated in a tightening condition, said adjuster loosening said chain around the head of the fastener when said adjuster is manipulated in a loosening condition.

6. The assembly according to claim 5, wherein said adjuster comprises:
a screw being rotatably disposed within said handle, said screw extending between said first end and said second end of said handle, said screw being aligned with said adjustment slot in said outer wall of said handle;
a knob being rotatably disposed on said first end of said handle thereby facilitating said knob to be rotated, said screw being attached to said knob such that said screw rotates when said knob is rotated, said knob being rotatable in a first direction or a second direction; and
a nut being rotatably attached to said knob, said nut compressing said knob against said first end of said handle when said nut is tightened to inhibit said knob from rotating, said nut disengaging said knob when said nut is loosened to facilitate said knob to be rotated.

7. The assembly according to claim 6, wherein:
said chain has a primary end and a secondary end, said chain having a bar being disposed on said secondary end of said chain; and
said adjuster includes:
a sleeve being positioned around said handle, said sleeve being slidable between said first end and said second end of said handle; and
a hook being coupled to and extending downwardly from said sleeve, said hook curving toward said first end of said handle, said hook engaging said bar on said secondary end of said chain.

8. The assembly according to claim 7, wherein said adjuster includes a pin being coupled to said sleeve and extending through said adjustment slot in said outer wall of said handle, said screw extending through said pin such that said pin threadably engages said screw, said pin traveling along said screw when said screw is rotated.

9. The assembly according to claim 8, wherein said sleeve travels toward said first end of said handle when said knob is rotated in said first direction thereby tightening said chain around the head of the fastener.

10. The assembly according to claim 8, wherein said sleeve travels toward said second end of said handle when said knob is rotated in said second direction thereby loosening said chain around the head of the fastener.

11. A chain wrench assembly being wrappable around a head of a fastener for tightening or loosening the fastener, said assembly comprising:
a handle having a heel being positionable against a head of a fastener, said handle having a first end and a second end, said second end being rounded to define said heel, said heel curving away from a centerline of said handle extending between said first end and said second end, said handle being substantially hollow, said handle having an adjustment slot extending through an outer wall of said handle, said adjustment slot being elongated to extend a substantial length between said first end and said second end;
a slide being attached to said handle, said slide being spaced from said heel, said slide having a member being spaced from said outer wall of said handle, said slide being positioned between said heel and said adjustment slot,
a chain being coupled to said handle, said chain being extendable around the head of the fastener, said chain sliding through said slide such that said chain forms a closed loop around the head of the fastener, said chain having a plurality of gripping elements each being integrated into said chain, each of said gripping elements engaging the head of the fastener thereby facilitating said chain to rotate the head of the fastener when said handle is manipulated for tightening or loosening the fastener, said chain having a primary end, a secondary end and an engaging surface extending between said primary end and said secondary end, said primary end being coupled to said heel, each of said gripping elements being disposed on said engaging surface, said gripping elements being evenly spaced apart from each other and being distributed between said primary end and said secondary end thereby facilitating said gripping elements to accommodate angles between intersecting faces of the head of the fastener, each of said gripping elements having an outer surface which has a top side and a pair of lateral sides each sloping outwardly between said top side and said engaging surface of said chain such that each of said gripping elements has a trapezoidal shape, said chain having a bar being disposed on said secondary end of said chain; and
an adjuster being movably integrated into said handle, said adjuster engaging said chain, said adjuster tightening said chain around the head of the fastener when said adjuster is manipulated in a tightening condition, said adjuster loosening said chain around the head of the fastener when said adjuster is manipulated in a loosening condition, said adjuster comprising:
a screw being rotatably disposed within said handle, said screw extending between said first end and said second end of said handle, said screw being aligned with said adjustment slot in said outer wall of said handle;
a knob being rotatably disposed on said first end of said handle thereby facilitating said knob to be rotated, said screw being attached to said knob such that said screw rotates when said knob is rotated, said knob being rotatable in a first direction or a second direction;
a nut being rotatably attached to said knob, said nut compressing said knob against said first end of said handle when said nut is tightened to inhibit said knob from rotating, said nut disengaging said knob when said nut is loosened to facilitate said knob to be rotated;
a sleeve being positioned around said handle, said sleeve being slidable between said first end and said second end of said handle;
a hook being coupled to and extending downwardly from said sleeve, said hook curving toward said first end of said handle, said hook engaging said bar on said secondary end of said chain; and
a pin being coupled to said sleeve and extending through said adjustment slot in said outer wall of said handle, said screw extending through said pin such that said pin threadably engages said screw, said pin traveling along said screw when said screw is rotated, said sleeve traveling toward said first end of said handle when said knob is rotated in said first direction thereby tightening said chain around the head of the fastener, said sleeve traveling toward said second end of said handle when said knob is rotated in said second direction thereby loosening said chain around the head of the fastener.
